(19) United States
(12) Patent Application Publication
(10) Pub. No.: US 2015/0214794 A1
(43) Pub. Date: Jul. 30, 2015

(54) Rotor of an Alternator

(71) Applicant: Victory Industrial Corporation, New Taipei City (TW)

(72) Inventors: Hung-Chih CHANG, New Taipei City (TW); Ping-Feng Tsai, New Taipei City (TW)

(73) Assignee: Victory Industrial Corporation, New Taipei City (TW)

(21) Appl. No.: 14/167,916

(22) Filed: Jan. 29, 2014

(30) Foreign Application Priority Data
Jan. 29, 2014 (TW) 103 103 634

(51) Int. Cl. H02K 1/24; H02K 1/27

(52) U.S. Cl. CPC H02K 1/243; H02K 1/27

(57) ABSTRACT

The present invention relates to a rotor for an alternator, including a first claw pole element and an opposite second claw pole element and a plurality of N-pole claw-shaped bodies of the first claw pole element and a plurality of S-pole claw-shaped bodies of the second claw pole element being respectively adjacent to each other and spaced apart; wherein a permanent magnet is fixed between each of the N-pole claw-shaped bodies of the first claw pole element and each of the S-pole claw-shaped bodies of the second claw pole element which are adjacent to each other, to increase a magnetic field generated after the rotor is electromagnetically conducted and decrease magnetic leakage between the two pole elements, thereby increasing generating capacity of the alternator.

### CROSS-REFERENCE TO RELATED APPLICATIONS

This application claims the benefit of priority to the commonly-owned TW patent application no. 103 103 634, filed Jan. 29, 2014, entitled “Rotor of an Alternator,” which is herein incorporated by reference in its entirety for all purposes.

### BACKGROUND OF THE INVENTION

The present invention relates to improvement of a rotor for an alternator, and in particular, to improvement of a rotor for a vehicle alternator, which can further increase generating capacity of the vehicle alternator.

An alternator is a power generation device that uses a rotor and a stator to generate electromagnetic interaction therebetween, thereby generating AC power.

In terms of the vehicle alternator, when a vehicle starts, it is necessary to start a motor by means of a vehicle battery to drive an engine to start, and then the engine drives the alternator to operate, so that the alternator charges the vehicle battery and generates sufficient current, to supply power needed by electronic components in the vehicle.

The alternator includes a rotor and a stator. As shown in FIG. 1, the rotor 1 of the alternator may rotate relative to the stator (not shown). The rotor includes a pole 12, a magnetic-field coil 13, a slip ring 14, a shaft 15 and a bearing 16. When power of the vehicle battery is supplied to the magnetic-field coil 13 via the slip ring 14, the pole 12 can be magnetized due to an electromagnetic induction effect to generate a magnetic field; and when the rotor 1 rotates, the direction of the magnetic field also changes with rotation of the rotor.

The stator of the alternator surrounds the rotor 1. The stator consists of one or more sets of stator coils and a magnetic core. When the rotor 1 rotates relative to the stator, the stator coils may generate an alternating current due to electromagnetic induction between the stator and the rotor.

After an electric current enters the magnetic-field coil 13 of the rotor 1, a first claw pole element 2 and a second claw pole element 3 of the pole 12 can be magnetized into an N pole and an S pole respectively due to electromagnetic induction so that each pair of adjacent claw-shaped bodies 121, 123 of the claw pole elements can generate a magnetic field, and when the rotor 1 rotates, directions of the magnetic fields also change with rotation of the rotor 1 to further create electromagnetic induction with the stator coils of the stator to generate an alternating current.

In view of the above, the stronger the magnetic field generated by the pole 12 of the rotor 1 is, the more the amount of the alternating current that can be generated is. However, for the rotor 1 of a generally conventional alternator, after an electric current enters the magnetic-field coil 13 and when the first claw pole element 2 and the second claw pole element 3 of the pole 12 can be magnetized into an N pole and an S pole respectively due to electromagnetic induction, part of the magnetic lines may directly pass from a space between two adjacent claw-shaped bodies 121, 123 of the claw pole elements and may not participate in formation of the magnetic field of the pole 12, and such a phenomenon is called “magnetic leakage.” The occurrence of magnetic leakage may cause unnecessary magnetic loss, and reduce the strength of the magnetic field formed by the pole, which further reduces the generating capacity of the alternator.

In view of this, there is a demand for an improved rotor for an alternator.

### SUMMARY OF THE INVENTION

A main objective of the present invention is to provide a rotor for an alternator, wherein a permanent magnet is disposed between at least one claw-shaped body of each of two mutually combined claw pole elements so as to avoid magnetic leakage between the two pole elements.

Another objective of the present invention is to provide a rotor for an alternator, wherein a permanent magnet is disposed between at least one claw-shaped body of each of two mutually combined claw pole elements, so as to enhance the magnetic field generated by the pole of the rotor, to further increase the generating capacity of the alternator.

A further objective of the present invention is to provide a rotor for an alternator, which covers a cover made of a non-magnetic material on a surface of the permanent magnet towards an outer side of the pole, so as to protect the permanent magnet, further enhance the magnetic field generated by the pole of the rotor, and increase the generating capacity of the alternator.

To achieve the above objectives, the rotor for an alternator in accordance with an embodiment of the present invention, comprises a first claw pole element and a second claw pole element opposite thereto, wherein the first claw pole element has a plurality of N-pole claw-shaped bodies, the second claw pole element has S-pole claw-shaped bodies of which the amount is the same as that of the plurality of N-pole claw-shaped bodies of the first claw pole element, and when the first claw pole element and the second claw pole element are combined with each other, the plurality of N-pole claw-shaped bodies of the first claw pole element and the plurality of S-pole claw-shaped bodies of the second claw pole element are respectively adjacent to each other and spaced apart; wherein a permanent magnet is fixed between at least one N-pole claw-shaped body of the first claw pole element and at least one S-pole claw-shaped body of the second claw pole element which are adjacent to each other, wherein an N polar end of the permanent magnet is in contact with the N-pole claw-shaped body of the first claw pole element, and an S polar end of the permanent magnet is in contact with the S-pole claw-shaped body of the second claw pole element.

In another aspect, the permanent magnet is fixed between the claw-shaped body of the first claw pole element and the claw-shaped body of the second claw pole element in an embedded manner, and wherein the N polar end of the permanent magnet is embedded into the claw-shaped body of the first claw pole element and the S polar end of the permanent magnet is embedded into the claw-shaped body of the second claw pole element.

In another aspect, the rotor further comprises a cover for the permanent magnet, wherein the cover is made of a non-magnetic material and substantially covers an outer surface of the permanent magnet.

In another aspect, the cover is made of a stainless steel material.

In another aspect, the permanent magnet is fixed between the claw-shaped body of the first claw pole element and the claw-shaped body of the second claw pole element by an adhesive.

In another aspect, two opposite sides of the claw-shaped body of the first claw pole element and the claw-shaped body of the second claw pole element adjacent thereto are respectively provided with a groove corresponding to each other, and wherein the N polar end of the permanent magnet is received in the groove of the claw-shaped body of the first claw pole element and the S polar end of the permanent magnet is received in the groove of the claw-shaped body of the second claw pole element.

In another aspect, the rotor further comprises multiple concave portions, wherein each concave portion is formed between inner sides of the claw-shaped body of the first claw pole element and the claw-shaped body of the second claw pole element adjacent thereto, wherein the permanent magnet is received in the concave portion, and wherein the N polar end of the permanent magnet abuts against the claw-shaped body of the first claw pole element, and the S polar end of the permanent magnet abuts against the claw-shaped body of the second claw pole element.

In another aspect, the grooves are formed by turn-milling.

In another aspect, the concave portion is formed by turn-milling.

In another aspect, the permanent magnet is respectively fixed between each of the claw-shaped bodies of the first claw pole element and each of the claw-shaped bodies of the second claw pole element which are adjacent to each other.

In another aspect, the amount of the claw-shaped bodies of the first claw pole element and the amount of the claw-shaped bodies of the second claw pole element are even number.

Further, the present invention is directed to a vehicle alternator comprising the above rotor.

In another aspect, the permanent magnet is fixed between the claw-shaped body of the first claw pole element and the claw-shaped body of the second claw pole element in an embedded manner, and wherein the N polar end of the permanent magnet is embedded into the claw-shaped body of the first claw pole element and the S polar end of the permanent magnet is embedded into the claw-shaped body of the second claw pole element.

In another aspect, the rotor further comprises a cover for the permanent magnet, wherein the cover is made of a non-magnetic material and substantially covers an outer surface of the permanent magnet.

In another aspect, the cover is made of a stainless steel material.

In another aspect, the permanent magnet is fixed between the claw-shaped body of the first claw pole element and the claw-shaped body of the second claw pole element by an adhesive.

In another aspect, two opposite sides of the claw-shaped body of the first claw pole element and the claw-shaped body of the second claw pole element adjacent thereto are respectively provided with a groove corresponding to each other, and wherein the N polar end of the permanent magnet is received in the groove of the claw-shaped body of the first claw pole element and the S polar end of the permanent magnet is received in the groove of the claw-shaped body of the second claw pole element.

In another aspect, the rotor further comprises multiple concave portions, wherein each concave portion is formed between inner sides of the claw-shaped body of the first claw pole element and the claw-shaped body of the second claw pole element adjacent thereto, wherein the permanent magnet is received in the concave portion, and wherein the N polar end of the permanent magnet abuts against the claw-shaped body of the first claw pole element, and the S polar end of the permanent magnet abuts against the claw-shaped body of the second claw pole element.

In another aspect, the grooves are formed by turn-milling.

In another aspect, the concave portion is formed by turn-milling.

In another aspect, the permanent magnet is respectively fixed between each of the claw-shaped bodies of the first claw pole element and each of the claw-shaped bodies of the second claw pole element which are adjacent to each other.

In another aspect, the amount of the claw-shaped bodies of the first claw pole element and the amount of the claw-shaped bodies of the second claw pole element are even number.

In order to better understand the following detailed description of the present invention, the foregoing has rather broadly generalized the features and technical advantages of the present invention. The additional features and advantages of the present invention will be described below. Persons skilled in the art should recognize that the concepts and specific implementation manners disclosed can be easily modified or designed as the basis of other structures implementing the same purposes of the present invention. Persons skilled in the art should also recognize that such equivalent constructions do not depart from the spirit and scope of the present invention claimed in the claims.

### BRIEF DESCRIPTION OF THE DRAWING

FIG. 1 is an exploded view of a conventional rotor of an alternator;

FIG. 2 is a schematic view of composition of a pole of a rotor for an alternator according to the present invention;

FIG. 3 is a three-dimensional view of a permanent magnet and its cover according to the present invention;

FIG. 4 is a sectional view taken along Line A-A in FIG. 2 of one embodiment in which the permanent magnet and its cover are mounted to the pole according to the present invention;

FIG. 5 is a sectional view taken along Line A-A in FIG. 2 of another embodiment in which the permanent magnet and its cover are mounted to the pole according to the present invention; and

FIG. 6 is a graph drawn according to Table 1.

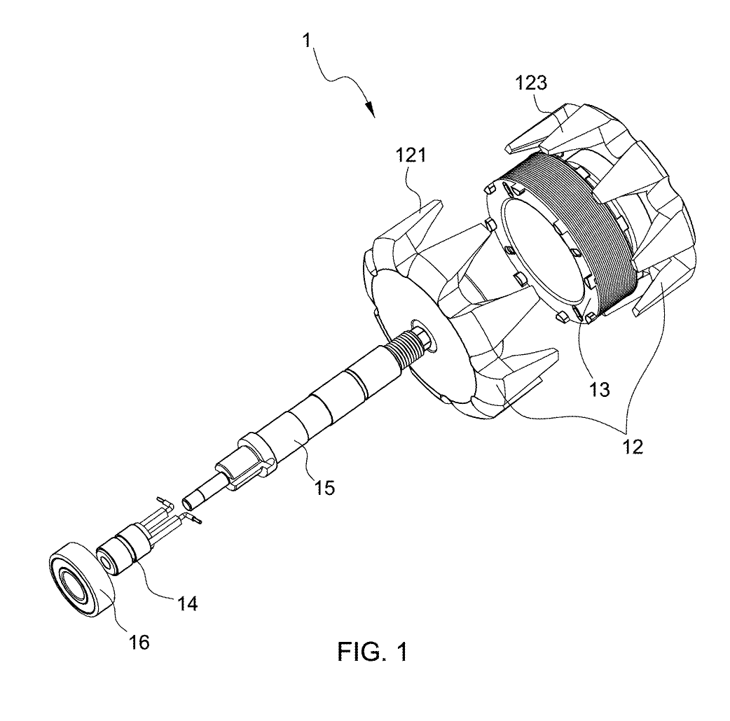

### DETAILED DESCRIPTION

The best embodiments of the present invention are described as follows with reference to the drawings, and the element reference numerals are shown in the drawings to indicate corresponding elements.

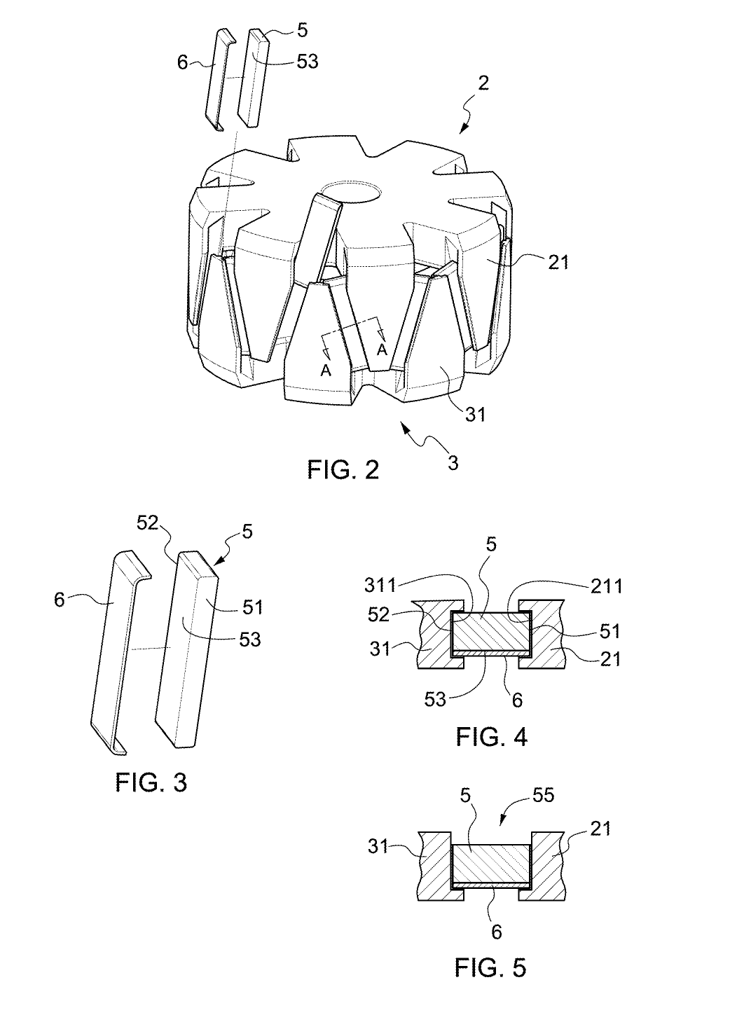

The present invention mainly makes further improvement to a conventional rotor of an alternator, especially directed to the improvement to a pole of the rotor (as shown in FIG. 2).

The pole of the rotor includes a first claw pole element 2 and a second claw pole element 3 opposite thereto (please refer to FIG. 2). The first claw pole element 2 may include two, four, six or eight claw-shaped bodies 21, and the second claw pole element 3 may include two, four, six or eight claw-shaped bodies 31, wherein the amount of the claw-shaped bodies 21 of the first claw pole element 2 is the same as that of the claw-shaped bodies 31 of the second claw pole element 3.

The first claw pole element 2 and the second claw pole element 3 are combined into the pole by means of mutual engagement so that the claw-shaped bodies 21 of the first claw pole element 2 and the claw-shaped bodies 31 of the second claw pole element 3 are pairwise adjacent to each other and spaced apart. After an electric current enters the magnetic-pole coil of the rotor, the first claw pole element 2 may be magnetized into an N pole due to electromagnetic induction, and the second claw pole element 3 may be magnetized into an S pole due to electromagnetic induction; in this way, a magnetic line may be generated between each pair of the claw-shaped body 21 of the first claw pole element 2 forming the N pole and the claw-shaped body 31 of the second claw pole element 3 forming the S pole which are adjacent to each other, thereby forming a magnetic field. If a magnetic-pole coil is wound in a direction opposite to that of the above magnetic-pole coils, the first claw pole element 2 is magnetized into an S pole due to electromagnetic induction, and the second claw pole element 3 is magnetized into an N pole due to electromagnetic induction; similarly, a magnetic line may also be generated between each pair of the claw-shaped body 21 of the first claw pole element 2 forming the S pole and the claw-shaped body 31 of the second claw pole element 3 forming the N pole which are adjacent to each other, thereby forming a magnetic field.

As shown in FIG. 3, the present invention mainly disposes a permanent magnet 5 or a permanent magnet 5 and its cover 6 between each pair of the claw-shaped body 21 and the claw-shaped body 31 which are adjacent to each other. As shown in FIG. 2, the permanent magnet 5 may be fixed between each pair of the claw-shaped body 21 and the claw-shaped body 31 which are adjacent to each other. An N polar end 51 of the permanent magnet 5 is in contact with the claw-shaped body 21 of the first claw pole element 2 that forms the N pole, and an S polar end 52 of the permanent magnet 5 is in contact with the claw-shaped body 31 of the second claw pole element 3 that forms the S pole. In this way, when an electric current enters the magnetic-pole coil of the rotor and a magnetic field is formed between each pair of the claw-shaped body 21 and the claw-shaped body 31, the permanent magnet 5 can block linear passing of the magnetic lines of the claw-shaped bodies 21 and 31 which are adjacent to each other, and avoid occurrence of magnetic leakage, so as to enhance the magnetic field formed by the claw-shaped bodies 21 and 31 which are adjacent to each other, and further increase the generating capacity of the alternator.

If the first claw pole element 2 is magnetized into an S pole due to electromagnetic induction, and the second claw pole element 3 is magnetized into an N pole due to electromagnetic induction, the permanent magnet 5 is set in such a manner that its N polar end 51 is in contact with the claw-shaped body 31 of the second claw pole element 3 and its S polar end 52 is in contact with the claw-shaped body 21 of the first claw pole element 2.

In short, when the permanent magnet 5 is fixed between each pair of the claw-shaped body 21 and the claw-shaped body 31 which are adjacent to each other and generate polarities due to electromagnetic induction, one polar end of the permanent magnet 5 is in contact with the claw-shaped body having the same polarity.

In terms of the effect of increasing the generating capacity that can be achieved by the rotor of the present invention, experimental comparisons are made among an alternator (I) of a rotor whose pole not provided with a permanent magnet, an alternator (II) of a rotor whose pole has eight pairs of claw-shaped bodies provided with sixteen permanent magnets arranged in the above manner, and an alternator (III) of a rotor whose pole has six pairs of claw-shaped bodies provided with twelve permanent magnets arranged in the above manner.

The following Table 1 shows generating capacity that can be generated by the three kinds of alternators (I, II and III) at various rotation speeds:

TABLE 1

| | Speed (RPM) | | | | | | | | | |
|---|---|---|---|---|---|---|---|---|---|---|
| | 1500 | 1600 | 1800 | 2500 | 3000 | 4000 | 5000 | 6000 | 7000 | 8000 |
| Generating | 99.0 | 106.7 | 127.4 | 163.2 | 174.2 | 183.3 | 188.6 | 191.8 | 193.7 | 194.8 |
| capacity of (II) | | | | | | | | | | |
| (Amps) | | | | | | | | | | |
| Generating | 71.0 | 87.1 | 111.1 | 156.8 | 170.3 | 182.3 | 187.9 | 191.1 | 193.7 | 195.7 |
| capacity of (III) | | | | | | | | | | |
| (Amps) | | | | | | | | | | |
| Generating | 48.7 | 68.5 | 84.4 | 109.9 | 123.8 | 136.5 | 143.4 | 147.0 | 149.5 | 150.8 |
| capacity of (I) | | | | | | | | | | |
| (Amps) | | | | | | | | | | |

It can be known according to Table 1 that the generating capacity generated from the alternator (II or III) with the rotor where a permanent magnet is disposed between adjacent N-pole and S-pole claw-shaped bodies of the pole thereof is greater than that of the alternator (I) with the rotor where no permanent magnet is disposed in the pole.

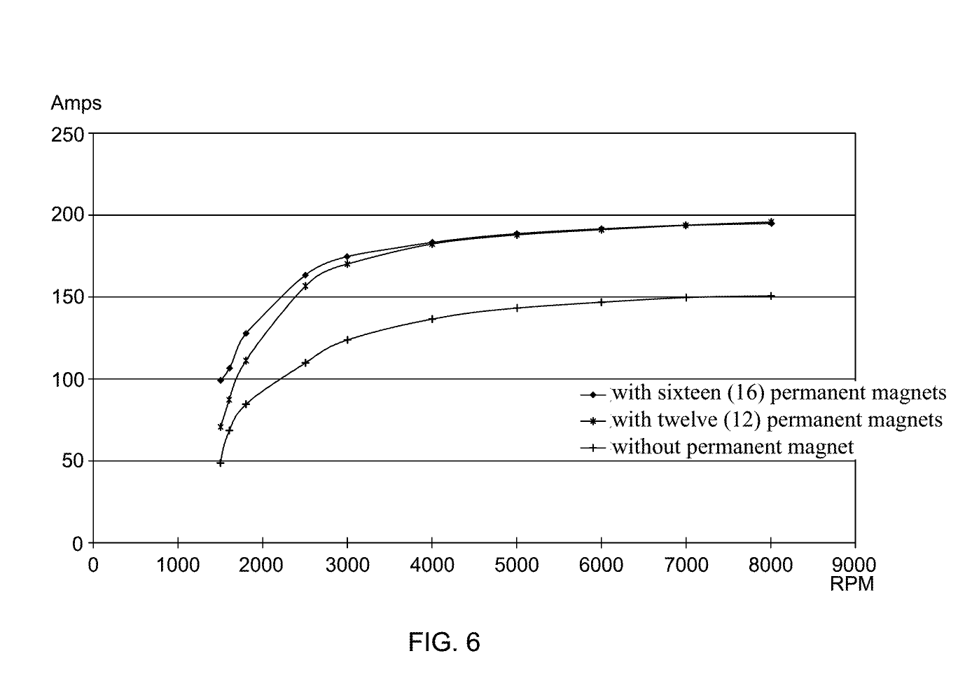

Further, referring to the graph (see FIG. 6) drawn according to the values in Table 1, in addition to the comparison result showing that the generating capacity generated from the alternator (II or III) with the rotor where a permanent magnet is disposed between adjacent N-pole and S-pole claw-shaped bodies of the pole is greater than that of the alternator (I) with the rotor where no permanent magnet is disposed in the pole thereof, it can also be found that when the rotor operates at a low speed (lower than 3000 RPM), the generating capacity increased and generated by the alternator (II or III) of the rotor where a permanent magnet is disposed in the pole thereof is especially remarkable.

Also, if an outer surface 53 of the permanent magnet 5 towards an outer side of the pole fixed between adjacent claw-shaped bodies 21 and 31 is further covered with a cover 6 made of a non-magnetic material, as shown in FIG. 2, in addition that the permanent magnet 5 is protected with its rigidity and magnetic leakage can be further avoided due to non-magnetic properties of the material, the magnetic field can be further enhanced so as to achieve a better technical effect. The non-magnetic material may be a stainless steel material.

The permanent magnet 5 or the permanent magnet 5 and its cover 6 may be fixed between two adjacent claw-shaped bodies 21 and 31 in an embedded manner. FIG. 4 shows a manner of embedding the permanent magnet 5 and its cover 6 between two adjacent claw-shaped bodies 21 and 31, according to a section taken along Line A-A in FIG. 2, wherein two opposite sides of a claw-shaped body 21 of the first claw pole element 2 and a claw-shaped body 31 of the second claw pole element 3 adjacent thereto may be respectively provided with a groove 211 and a groove 311 by means of turn-milling, and the permanent magnet 5 and its cover 6 may utilize the two grooves 211 and 311 so as to be embedded between the two adjacent claw-shaped bodies 21 and 31. The N polar end 51 of the permanent magnet 5 is received in the groove 211 of the N-pole claw-shaped body 21, and the S polar end 52 thereof is received in the groove 311 of the S-pole claw-shaped body 31. In addition, FIG. 5 shows another manner of embedding the permanent magnet 5 and its cover 6 between two adjacent claw-shaped bodies 21 and 31, according to a section taken along Line A-A in FIG. 2, wherein a concave portion 55 is formed between inner sides of the claw-shaped bodies 21 and 31 by means of turn-milling, and the permanent magnet 5 and its cover 6 may be received in the concave portion 55 so as to be embedded between the two adjacent claw-shaped bodies 21 and 31. The N polar end 51 of the permanent magnet 5 abuts against the N-pole claw-shaped body 21, and the S polar end 52 thereof abuts against the S-pole claw-shaped body 31.

To enable the permanent magnet 5 or the permanent magnet 5 and its cover 6 to be further fixed between the adjacent claw-shaped bodies 21 and 31, an adhesive can be further applied between the permanent magnet 5 or the permanent magnet 5 and its cover 6 and the claw-shaped bodies 21 and 31.

The rotor of the present invention is applied to alternator systems, for example, alternator systems of power systems and vehicles. The rotor of the present invention especially suitably serves as a rotor structure of an alternator for automobiles.

The present invention should not be construed as being limited to the above specific embodiments, but should be construed as including various aspects of the invention as presented by the appended claims. Different variations of multiple structures and equivalent methods the same as those to which the present invention may be applied will be obvious in the art according to the disclosure in the specification. For example, the permanent magnets are fixed between two adjacent claw-shaped bodies in other different manners, or permanent magnets are only disposed between part of two adjacent claw-shaped bodies, and permanent magnets are not disposed between the rest two adjacent claw-shaped bodies, which also achieves the technical effect that the present invention can achieve. The claims of the present application include such modifications and apparatuses.

### DESCRIPTIONS ABOUT REFERENCE SIGNS

1 Rotor
12 Pole
13 Magnetic-field coil
14 Slip ring
15 Shaft
16 Bearing
2 First claw pole element
21 Claw-shaped body
211 Groove
3 Second claw pole element
31 Claw-shaped body
311 Groove
5 Permanent magnet
51 N polar end of the permanent magnet
52 S polar end of the permanent magnet
53 Outer surface of the permanent magnet
55 Concave portion
6 Cover

We claim:

1. A rotor for an alternator, comprising a first claw pole element and a second claw pole element opposite thereto, wherein the first claw pole element has a plurality of N-pole claw-shaped bodies, the second claw pole element has S-pole claw-shaped bodies of which the amount is the same as that of the plurality of N-pole claw-shaped bodies of the first claw pole element and when the first claw pole element and the second claw pole element are combined with each other, the plurality of N-pole claw-shaped bodies of the first claw pole element and the plurality of S-pole claw-shaped bodies of the second claw pole element are respectively adjacent to each other and spaced apart;
characterized in that, a permanent magnet is fixed between at least one N-pole claw-shaped body of the first claw pole element and at least one S-pole claw-shaped body of the second claw pole element which are adjacent to each other, wherein an N polar end of the permanent magnet is in contact with the N-pole claw-shaped body of the first claw pole element, and an S polar end of the permanent magnet is in contact with the S-pole claw-shaped body of the second claw pole element.

2. The rotor of claim 1, wherein the permanent magnet is fixed between the claw-shaped body of the first claw pole element and the claw-shaped body of the second claw pole element in an embedded manner, and wherein the N polar end of the permanent magnet is embedded into the claw-shaped body of the first claw pole element and the S polar end of the permanent magnet is embedded into the claw-shaped body of the second claw pole element.

3. The rotor of claim 1, further comprising a cover for the permanent magnet, wherein the cover is made of a non-magnetic material and substantially covers an outer surface of the permanent magnet.

4. The rotor of claim 3, wherein the cover is made of a stainless steel material.

5. The rotor of claim 1, wherein the permanent magnet is fixed between the claw-shaped body of the first claw pole element and the claw-shaped body of the second claw pole element by an adhesive.

6. The rotor of claim 2, wherein two opposite sides of the claw-shaped body of the first claw pole element and the claw-shaped body of the second claw pole element adjacent thereto are respectively provided with a groove corresponding to each other, and wherein the N polar end of the permanent magnet is received in the groove of the claw-shaped body of the first claw pole element and the S polar end of the permanent magnet is received in the groove of the claw-shaped body of the second claw pole element.

7. The rotor of claim 2, further comprising multiple concave portions, wherein each concave portion is formed between inner sides of the claw-shaped body of the first claw pole element and the claw-shaped body of the second claw pole element adjacent thereto, wherein the permanent magnet is received in the concave portion, and wherein the N polar end of the permanent magnet abuts against the claw-shaped body of the first claw pole element, and the S polar end of the permanent magnet abuts against the claw-shaped body of the second claw pole element.

8. The rotor of claim 6, wherein the grooves are formed by turn-milling.

9. The rotor of claim 7, wherein the concave portion is formed by turn-milling.

10. The rotor of claim 1, wherein the permanent magnet is fixed between each of the claw-shaped bodies of the first claw pole element and each of the claw-shaped bodies of the second claw pole element which are adjacent to each other.

11. The rotor of claim 1, wherein the amount of the claw-shaped bodies of the first claw pole element and the amount of the claw-shaped bodies of the second claw pole element are even number.

12. A vehicle alternator comprising a rotor of claim 1.

13. The vehicle alternator of claim 12, wherein the permanent magnet is fixed between the claw-shaped body of the first claw pole element and the claw-shaped body of the second claw pole element in an embedded manner, and wherein the N polar end of the permanent magnet is embedded into the claw-shaped body of the first claw pole element and the S polar end of the permanent magnet is embedded into the claw-shaped body of the second claw pole element.

14. The vehicle alternator of claim 12, further comprising a cover for the permanent magnet, wherein the cover is made of a non-magnetic material and substantially covers an outer surface of the permanent magnet.

15. The vehicle alternator of claim 14, wherein the cover is made of a stainless steel material.

16. The vehicle alternator of claim 12, wherein the permanent magnet is fixed between the claw-shaped body of the first claw pole element and the claw-shaped body of the second claw pole element by an adhesive.

17. The vehicle alternator of claim 13, wherein two opposite sides of the claw-shaped body of the first claw pole element and the claw-shaped body of the second claw pole element adjacent thereto are respectively provided with a groove corresponding to each other, and wherein the N polar end of the permanent magnet is received in the groove of the claw-shaped body of the first claw pole element and the S polar end of the permanent magnet is received in the groove of the claw-shaped body of the second claw pole element.

18. The vehicle alternator of claim 13, further comprising multiple concave portions, wherein each concave portion is formed between inner sides of the claw-shaped body of the first claw pole element and the claw-shaped body of the second claw pole element adjacent thereto, wherein the permanent magnet is received in the concave portion, and wherein the N polar end of the permanent magnet abuts against the claw-shaped body of the first claw pole element, and the S polar end of the permanent magnet abuts against the claw-shaped body of the second claw pole element.

19. The vehicle alternator of claim 17, wherein the grooves are formed by turn-milling.

20. The vehicle alternator of claim 18, wherein the concave portion is formed by turn-milling.

21. The vehicle alternator of claim 12, wherein the permanent magnet is fixed between each of the claw-shaped bodies of the first claw pole element and each of the claw-shaped bodies of the second claw pole element which are adjacent to each other.

22. The vehicle alternator of claim 12, wherein the amount of the claw-shaped bodies of the first claw pole element and the amount of the claw-shaped bodies of the second claw pole element are even number.
